(19) United States
(12) Patent Application Publication
(10) Pub. No.: US 2014/0314425 A1
(43) Pub. Date: Oct. 23, 2014

(54) Full-Duplex Multi-Mode Fiber Communication

(71) Applicant: CISCO TECHNOLOGY, INC., San Jose, CA (US)

(72) Inventor: Luca Cafiero, Palo Alto, CA (US)

(73) Assignee: Cisco Technology, Inc., San Jose, CA (US)

(21) Appl. No.: 13/864,319

(22) Filed: Apr. 17, 2013

(51) Int. Cl. H04B 10/27

(52) U.S. Cl. CPC H04B 10/27
USPC 398/141

(57) ABSTRACT

Techniques are presented herein to facilitate higher bandwidth communications in a data center using existing multi-mode fibers and full-duplex optical communication techniques. A first device transmits to a second device a first optical signal at a first wavelength on a first optical fiber. The first optical signal carries a first portion of Ethernet traffic. The first device receives a second optical signal transmitted at a second wavelength on the first optical fiber from the second device. The second optical signal carries a first portion of Ethernet traffic. On a second optical fiber, the first device transmits to the second device a third optical signal at a third wavelength. The third optical signal carries a second portion of Ethernet traffic. The first device receives a fourth optical signal at a fourth wavelength on the second optical fiber, the fourth optical signal carrying a second portion of Ethernet.

### TECHNICAL FIELD

The present disclosure relates to optical communication.

### BACKGROUND

There is a large installed base of multi-mode fiber in today's data centers. This fiber consists of bundles of two optical fibers that each can support up to 25 Gbps of data transmission using inexpensive components. Currently, these fiber bundles are used to carry 10 Gbps Ethernet traffic.

There is a market transition occurring to change the link speed from 10 Gbps Ethernet to 40 Gbps Ethernet in the data center. In order for this to happen, the existing fiber would need to be replaced. The new fiber will either be single-mode and require expensive transmission technology running at 40 Gbps or it will be an 8 optical strand bundle that uses 4 times the number of transmitters and receivers as the current 10 Gbps solutions.

### BRIEF DESCRIPTION OF THE DRAWINGS

FIG. 1 is a high level diagram illustrating full-duplex communication of Ethernet traffic over a pair of multi-mode optical fibers between first and second devices.

FIG. 2 is a block diagram illustrating the components in the first and second devices to facilitate the full-duplex communication of Ethernet traffic.

FIGS. 3 and 4 illustrate flow charts depicting operations performed in the first and second devices to facilitate the full-duplex communication of Ethernet traffic.

### DESCRIPTION OF EXAMPLE EMBODIMENTS

### Overview

Techniques are presented herein to facilitate higher bandwidth communications in a data center using existing multi-mode optical fibers. A first device transmits to a second device a first optical signal at a first wavelength on a first optical fiber. The first optical signal carries a first portion of Ethernet traffic from the first device to the second device. The first device receives a second optical signal transmitted at a second wavelength on the first optical fiber from the second device to the first device. The second optical signal carries a first portion of Ethernet traffic from the second device to the first device. On a second optical fiber, the first device transmits to the second device a third optical signal at a third wavelength. The third optical signal carries a second portion of Ethernet traffic. The first device receives a fourth optical signal at a fourth wavelength on the second optical fiber. The fourth optical signal carries a second portion of Ethernet traffic from the second device to the first device. Thus, simultaneous transmission (full-duplex communication) of two optical signals is performed in opposite directions on two optical fibers between the first and second devices to transport Ethernet traffic between the first and second devices.

### Example Embodiments

Presented herein are techniques to facilitate higher bandwidth communications in a data center using existing multi-mode fibers and full-duplex optical communication techniques. At the time of this writing, existing multi-mode fibers in data centers are used to carry 10 Gbps of Ethernet traffic (when converted to optical signals). Actually, these multi-mode fibers can handle even greater data rates before performance/degradation issues occur. For example, existing multi-mode fibers rated for 10 Gbps of Ethernet traffic can support up to 25 Gbps of Ethernet traffic.

According to the techniques presented herein, data is transmitted on each optical fiber in a fiber bundle (2 fibers) at 20 Gbps in both directions so that the existing 10 Gbps installed multi-mode fiber bundle can carry 40 Gbps of Ethernet traffic. Specifically, 20 Gbps of Ethernet traffic on two fibers will be transmitted from a first device to a second device for a total of 40 Gbps, and on the same two fibers 20 Gbps of Ethernet traffic from the second device to a first device, also for a total of 40 Gbps. This allows the existing fiber bundles deployed for 10 Gbps of Ethernet traffic in the data center to be re-used for 40 Gbps Ethernet traffic communication, without resorting to exotic and expensive transmission technology.

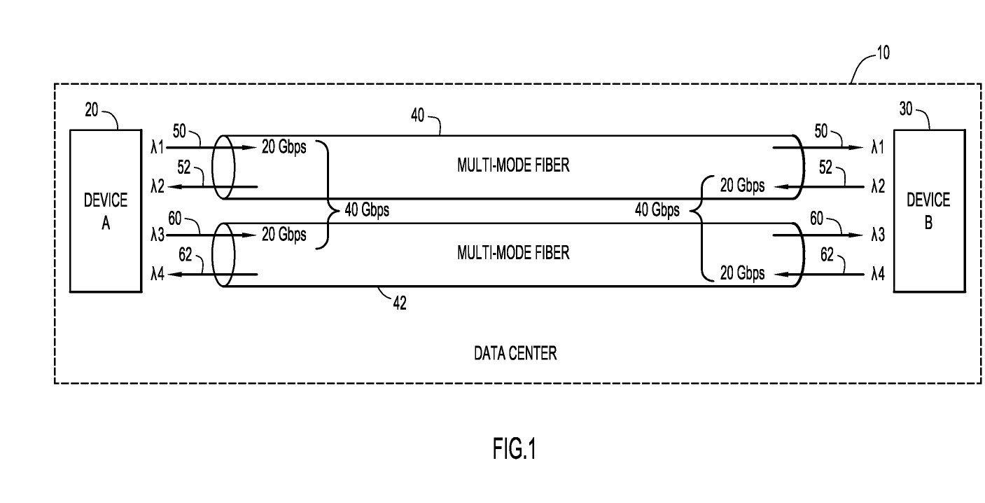

Specifically, to achieve the full-duplex operation in both fibers, i.e. transmission of data in both directions on a single fiber, two different wavelengths, one wavelength for each direction, is used in each fiber for transmission of the optical signals. Reference is now made to FIG. 1. FIG. 1 shows an optical communication system in a data center 10, for example, in which network traffic, e.g., Ethernet traffic, is to be communicated between first and second devices, shown at reference numerals 20 and 30, and denoted Device A and Device B, respectively. There is a pair of optical fibers 40 and 42 coupled between devices 20 and 30.

Device 20 transmits to device 30 a first optical signal 50 at a first wavelength (λ1) on the first optical fiber 40 in the pair. The first optical signal 50 carries a first portion of Ethernet traffic from device 20 to device 30. Device 30 transmits a second optical signal 52 at a second wavelength (λ2) on the first optical fiber 40. The second optical signal 52 carries a first portion of Ethernet traffic from the second device 30 to the first device 20.

Similarly, the first device 20 transmits to the second device 30 a third optical signal 60 at a third wavelength (λ3) on the second optical fiber 42. The third optical signal carries a second portion of Ethernet traffic from the first device 20 to the second device 30. The second device 30 transmits to the first device 20 a fourth optical signal 62 at a fourth wavelength (λ4) on the second optical fiber 42. The fourth optical signal 62 carries a second portion of Ethernet traffic from the second device 30 to the first device 20.

Using the techniques depicted in FIG. 1, the first device 20 allocates its predetermined bandwidth (e.g., 40 Gbps) of Ethernet traffic to be sent to the second device 30 between the first and second portions. The first device 20 sends a first portion (e.g., 20 Gbps) of the total of its Ethernet traffic, e.g. 40 Gbps, on the first optical signal 50 on the first fiber 40 to the second device 30, and a second (e.g., remaining) portion (e.g., 20 Gbps) of its Ethernet traffic on the third optical signal 60 on the second fiber 42 to the second device 30.

In a similar manner, the second device 30 allocates between a predetermined bandwidth of Ethernet traffic (e.g., 40 Gbps) between the first and second portions. The second device 30 sends a first portion (e.g., 20 Gbps) of the total of its Ethernet traffic, e.g. 40 Gbps, on the second optical signal 52 on the first fiber 40 to the first device 20, and a second (e.g., remaining) portion (e.g., 20 Gbps) of its Ethernet traffic on the fourth optical signal 62 on the second fiber 42 to the first device 20. Moreover, the first optical fiber 40 and second optical fiber 42 may each be capable of supporting an optical signal carrying 20 Gbps of traffic even though these fibers are “rated” for carrying 10 Gbps of traffic.

The first wavelength (λ1) is different from the second wavelength (λ2) so that the optical signals 50 and 52 can be transmitted simultaneously (full-duplex) over the same fiber in opposite directions. Similarly, the third wavelength (λ3) is different from the fourth wavelength (λ4) so that optical signals 60 and 62 can be transmitted simultaneously (full-duplex) over the same fiber in opposite directions. However, the first wavelength (λ1) used in the first fiber 40 may or may not be the same as the third wavelength (λ3) used in the second fiber Likewise, the second wavelength (λ2) may or may not be the same as the fourth wavelength (λ2) used in the second fiber 42.

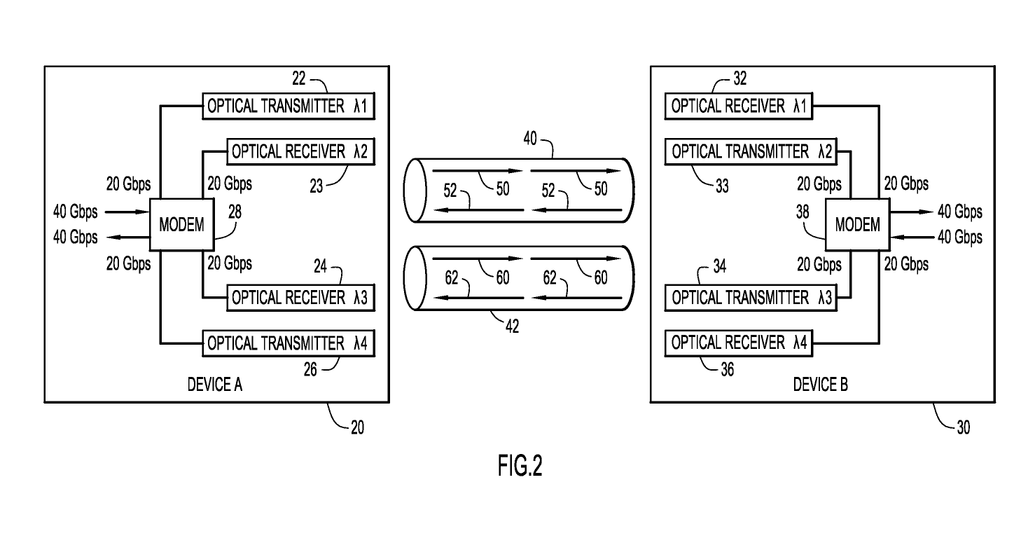

Reference is now made to FIG. 2. FIG. 2 illustrates in more detail the components that may reside at the first and second devices 20 and 30 to enable the techniques depicted in FIG. 1. Device 20 includes an optical transmitter 22 and an optical receiver 23 for use in connection with the first optical fiber 40, an optical transmitter 24 and an optical receiver 26 for use in connection with the second optical fiber 42, and a modem 28. The modem 28 performs the necessary modulation and demodulation in the electrical domain, and is connected to the optical transmitter 22, optical receiver 23, optical transmitter 24 and optical receiver 26. The modem 28 supplies 20 Gbps of Ethernet traffic to the optical transmitter 22 for transmission on optical signal 50 over the first optical fiber 40 on the first optical wavelength (λ1), and supplies 20 Gbps of Ethernet traffic to the optical transmitter 24 for transmission over the second optical fiber 42 on optical signal 60 at the third optical wavelength (λ3). Conversely, the modem 38 demodulates and recovers 20 Gbps of Ethernet traffic carried in the optical signal 52 received by the optical receiver 23 on the first optical fiber 40 on the second optical wavelength (λ2) and demodulates and recovers 20 Gbps of Ethernet traffic carried in the optical signal 62 received by the optical receiver 26 on the fourth optical wavelength (λ4).

Similarly, device 30 includes an optical transmitter 32 and an optical receiver 33 for use in connection with the first optical fiber 40, an optical transmitter 34 and an optical receiver 36 for use in connection with the second optical fiber 42, and a modem 38. The modem 38 performs the necessary modulation and demodulation in the electrical domain, and is connected to the optical transmitter 32, optical receiver 33, optical transmitter 34 and optical receiver 36. The modem 38 supplies 20 Gbps of Ethernet traffic to the optical transmitter 32 for transmission on optical signal 52 over the first optical fiber 40 at the second optical wavelength (λ2), and supplies 20 Gbps of Ethernet traffic to the optical transmitter 34 for transmission over the second optical fiber 42 on optical signal 62 at the fourth optical wavelength (λ4). Conversely, the modem 38 demodulates and recovers 20 Gbps of Ethernet traffic carried in the optical signal 50 received by the optical receiver 33 on the first optical fiber 40 at the first optical wavelength (λ1) and demodulates and recovers 20 Gbps of Ethernet traffic carried in the optical signal 60 received by the optical receiver 36 at the third optical wavelength (λ3).

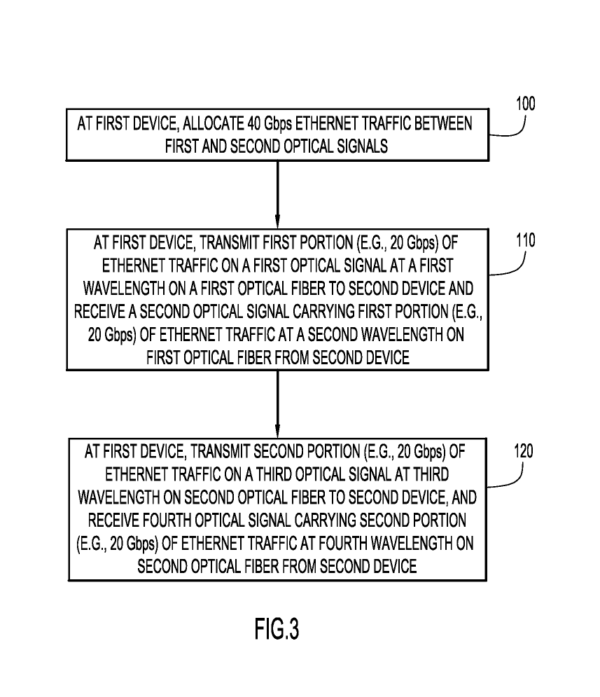

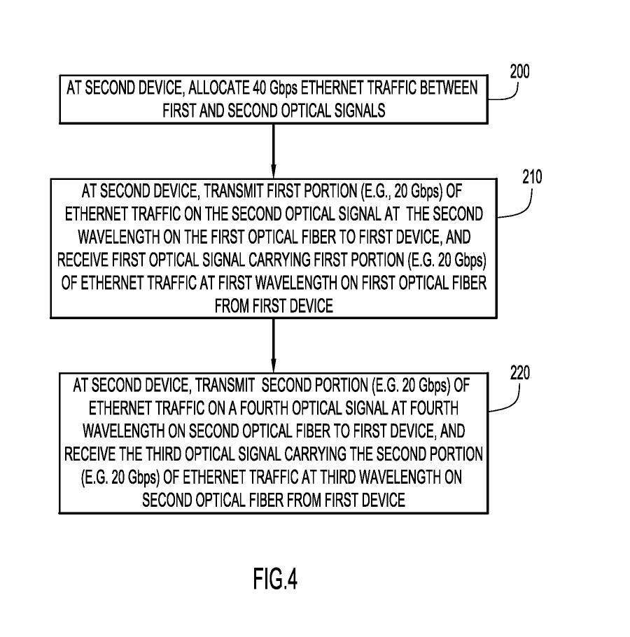

Turning now to FIGS. 3 and 4, flow charts that depict the operations performed in first device 20 and second device 30, respectively, on opposite ends of a communication link, are now described. Referring first to FIG. 3, at 100, the first device allocates, between first and second portions, a predetermined bandwidth of Ethernet traffic to be sent to the second device. The first portion is to be sent on a first optical signal on a first optical fiber and the second portion is to be sent on a second optical signal on a second optical fiber. At 110, the first device transmits to the second device a first portion (e.g., 20 Gbps) of Ethernet traffic on a first optical signal at a first wavelength on the first optical fiber, and receives a (second) optical signal carrying a first portion (e.g., 20 Gbps) of Ethernet traffic at a second wavelength on the first optical fiber from second device. At 120, the first device transmits to the second device a second portion (e.g., 20 Gbps) of Ethernet traffic on a third optical signal at a third wavelength on a second optical fiber, and receives a (fourth) optical signal at a fourth wavelength carrying a second portion (e.g., 20 Gbps) of Ethernet traffic on the second optical fiber from the second device.

The operations performed in the second device are now described with reference to FIG. 4. At 200, the second device allocates, between first and second portions, a predetermined bandwidth of Ethernet traffic to be sent to the first device. The first portion is to be sent on a second optical signal on the first optical fiber and the second portion is to be sent on a fourth optical signal on the second optical fiber. At 210, the second device transmits a first portion (e.g., 20 Gbps) of Ethernet traffic on a second optical signal at the second wavelength on the first optical fiber to the first device, and receives the first optical signal at the first wavelength carrying the first portion (e.g. 20 Gbps) of Ethernet traffic on the first optical fiber from the first device. At 220, the second device transmits a second portion (e.g., 20 Gbps) of Ethernet traffic on the fourth optical signal at the fourth wavelength on the first optical fiber to the first device, and receives the third optical signal at the third wavelength carrying the second portion (e.g. 20 Gbps) of Ethernet traffic on the second optical fiber from the first device.

In summary, techniques are presented herein to transmit a desired bandwidth (e.g., 40 Gbps) of Ethernet traffic over two multi-mode fibers by sending portions (e.g., 20 Gbps) of the desired bandwidth of Ethernet traffic on each fiber in both directions. This solution fully utilizes the existing installed fiber optic network in the data center to support 40 Gbps of Ethernet traffic with a very cost effective solution. Again, communication of 20 Gbps of Ethernet traffic is communicated in each direction on a first optical fiber capable of supporting up to 25 Gbps of Ethernet traffic, and similarly, communication of 20 Gbps of Ethernet traffic is communicated in each direction on a second optical fiber capable of supporting up to 25 Gbps of Ethernet traffic.

The above description is intended by way of example only.

What is claimed is:

1. A method comprising:
transmitting from a first device to a second device a first optical signal at a first wavelength on a first optical fiber, the first optical signal carrying a first portion of Ethernet traffic from the first device to the second device;
receiving a second optical signal at a second wavelength on the first optical fiber, the second optical signal carrying a first portion of Ethernet traffic from the second device to the first device;
transmitting from the first device to the second device a third optical signal at a third wavelength on a second optical fiber, the third optical signal carrying a second portion of Ethernet traffic from the first device to the second device; and
receiving a fourth optical signal at a fourth wavelength on the second optical fiber, the fourth optical signal carrying a second portion of Ethernet traffic from the second device to the first device.

2. The method of claim 1, further comprising, at the first device, allocating between the first and second portions a predetermined bandwidth of Ethernet traffic to be sent to the second device.

3. The method of claim 2, further comprising, at the second device, allocating between the first and second portions a predetermined bandwidth of Ethernet traffic to be sent to the first device.

4. The method of claim 3, wherein the predetermined bandwidth of Ethernet traffic to be sent from the first device to the second device is 40 Gbps, and the first portion and second portion are each 20 Gbps, and the predetermined bandwidth of Ethernet traffic to be sent from the second device to the first device is 40 Gbps, and the first portion and second portion are each 20 Gbps.

5. The method of claim 4, wherein transmitting and receiving are performed on the first optical fiber that is capable of supporting 20 Gbps, and transmitting and receiving are performed on the second optical fiber that is capable of supporting 20 Gbps.

6. The method of claim 1, wherein the third wavelength is the same as the first wavelength and the fourth wavelength is the same as the second wavelength.

7. The method of claim 1, further comprising:
receiving at the second device the first optical signal at the first wavelength on the first optical fiber;
transmitting from the second device the second optical signal on the second wavelength on the first optical fiber;
receiving at the second device the third optical signal at the third wavelength on the second optical fiber; and
transmitting the fourth optical signal at the fourth wavelength on the second optical fiber.

8. The method of claim 1, wherein transmitting and receiving are performed on the first optical fiber to communicate 20 Gbps of Ethernet traffic in each direction between the first and second devices on the first optical fiber that is capable of supporting up to 25 Gbps, and wherein transmitting and receiving are performed on the second optical fiber to communicate 20 Gbps of Ethernet traffic in each direction between the first and second devices on the second optical fiber that is capable of supporting up to 25 Gbps.

9. An apparatus:
a first optical transmitter configured to transmit from a first device to a second device a first optical signal carrying a first portion of Ethernet traffic at a first wavelength on a first optical fiber;
a first optical receiver configured to receive a second optical signal at a second wavelength on the first optical fiber, the second optical signal carrying a first portion of Ethernet traffic from the second device to the first device;
a second optical transmitter configured to transmit from the first device to the second device a third optical signal carrying a second portion of Ethernet traffic at a third wavelength on a second optical fiber; and
a second optical receiver configured to receive a fourth optical signal at a fourth wavelength on the second optical fiber, the fourth optical signal carrying a second portion of Ethernet traffic from the second device to the first device.

10. The apparatus of claim 9, further comprising a modem configured to allocate between the first and second portions a predetermined bandwidth of Ethernet traffic to be sent from the first device to the second device.

11. The apparatus of claim 9, wherein the predetermined bandwidth of Ethernet traffic to be sent from the first device to the second device is 40 Gbps, and the first portion and second portion are each 20 Gbps.

12. The apparatus of claim 11, wherein the first optical fiber is capable of supporting up to 25 Gbps, and the second optical fiber is capable of supporting up to 25 Gbps.

13. The apparatus of claim 9, wherein the third wavelength is the same as the first wavelength and the fourth wavelength is the same as the second wavelength.

14. The apparatus of claim 9, wherein the first optical transmitter and first optical receiver are configured to communicate 20 Gbps of Ethernet traffic in each direction between the first device and second device on the first optical fiber that is capable of supporting up to 25 Gbps, and the second optical transmitter and second optical receiver are configured to communicate 20 Gbps of Ethernet traffic in each direction between the first device and second device on the second optical fiber that is capable of supporting up to 25 Gbps.

15. A system comprising:
a first device and a second device;
first and second optical fibers coupled between the first device and second device;
the first device comprising:
a first optical transmitter configured to transmit from the first device to the second device a first optical signal carrying a first portion of Ethernet traffic at a first wavelength on the first optical fiber;
a first optical receiver configured to receive a second optical signal at a second wavelength on the first optical fiber, the second optical signal carrying a first portion of Ethernet traffic from the second device to the first device;
a second optical transmitter configured to transmit from the first device to the second device a third optical signal carrying a second portion of Ethernet traffic at a third wavelength on a second optical fiber; and
a second optical receiver configured to receive a fourth optical signal at a fourth wavelength on the second optical fiber, the fourth optical signal carrying a second portion of Ethernet traffic from the second device to the first device;
the second device comprising:
a first optical transmitter configured to transmit from the second device to the first device the second optical signal carrying the first portion of Ethernet traffic at the second wavelength on the first optical fiber;
a first optical receiver configured to receive the first optical signal at the first wavelength on the first optical fiber, the first optical signal carrying the first portion of Ethernet traffic from the first device to the second device; and
a second optical receiver configured to receive the third optical signal at the third wavelength on the second optical fiber, the third optical signal carrying the second portion of Ethernet traffic from the first device to the second device
a second optical transmitter configured to transmit from the second device to the first device the fourth optical signal carrying the second portion of Ethernet traffic at the fourth wavelength on the second optical fiber.

16. The system of claim 15, wherein the predetermined bandwidth of Ethernet traffic to be sent from the first device to the second device is 40 Gbps, and the first portion and second portion are each 20 Gbps, and the predetermined bandwidth of Ethernet traffic to be sent from the second device to the first device is 40 Gbps, and the first portion and second portion are each 20 Gbps.

17. The system of claim 16, wherein the first optical fiber is capable of supporting 20 Gbps, and the second optical fiber is capable of supporting 20 Gbps.

18. The system of claim 15, wherein the third wavelength is the same as the first wavelength and the fourth wavelength is the same as the second wavelength.

19. The system of claim 15, wherein the first optical fiber is capable of supporting up to 25 Gbps and the second optical fiber is capable of supporting up to 25 Gbps, and wherein the first and second devices are configured to communicate 20 Gbps of Ethernet traffic in each direction on the first optical fiber and 20 Gbps of Ethernet traffic in each direction on the second optical fiber.
